(19) United States
(12) Patent Application Publication
(10) Pub. No.: US 2007/0280224 A1
(43) Pub. Date: Dec. 6, 2007

(54) System and method for an output independent crossbar

(75) Inventor: Hsin-Yuan Ho, Cupertino, CA (US)

Correspondence Address: THOMAS, KAYDEN, HORSTEMEYER & RISLEY, LLP, 600 GALLERIA PARKWAY, STE 1500, ATLANTA, GA, 30339, US

(73) Assignee: VIA Technologies

(21) Appl. No.: 11/446,835

(22) Filed: Jun. 5, 2006

(51) Int. Cl. H04L 12/50

(52) U.S. Cl. 370/386; 370/392

(57) ABSTRACT

A memory exchange unit (“MXU”) in a GPU has an output independent crossbar. The crossbar comprises a writing controller having an input configured to receive a communication containing data and a destination ID. The crossbar includes a memory having a plurality of separate entities coupled to the writing controller. The writing controller searches for an available memory entity for storing the data and then writes the data to an available memory entity once identified. A reading component containing a plurality of reading controllers is coupled to each memory entity. Each reading controller corresponds to a particular output and reads data from a memory entity upon receiving indication that the memory entity contains data for its corresponding output. Upon reading and forwarding the data to the destination via the designated output, an availability status of the memory entity is returned to a state indicating availability for receiving other data.

### TECHNICAL FIELD

The present disclosure relates to graphic processing and, more particularly, to a system and method for implementing an output independent crossbar.

### BACKGROUND

Today's computer systems typically include multiple processors. For example, a graphics processing unit (GPU) is an example of a co-processor in addition to a primary processor, such as a central processing unit (CPU), that performs specialized processing tasks for which it is designed. In performing these tasks, the GPU may free the CPU to perform other tasks. In some cases, co-processors, such as a GPU, may physically reside on the computer system's motherboard along with the CPU, which may be a microprocessor. However, in other applications, as one of ordinary skill in the art would know, a GPU and/or other co-processing devices may reside on a separate but electrically coupled computer card, such as a graphics card in the case of a GPU.

It is generally recognized that the faster a GPU is configured to operate, or process instructions, the better the graphics produced by the GPU, and, therefore, the better the GPU. However, as one of ordinary skill in the art would know, a GPU, which may have a processing pipeline of various components, is configured to perform calculations and operations in a prescribed order and/or manner. Thus, situations may arise wherein a portion of the GPU's processing components may be idle while waiting for data to be processed by another portion of the GPU's components. Thus, in this nonlimiting example, to the extent that components may be configured for performing calculations on other operations, as opposed to waiting idly for a next instruction, the GPU may operate faster and more efficiently.

In a similar way, the components of a GPU may be coupled to utility-related components that move data within the processing components of the GPU. Because, as one of ordinary skill in the art would know, of the relatively large number of components that may reside on a GPU, routing data between the various components in a timely manner may be a complicated operation.

One such device that may be found in a GPU, as one of ordinary skill in the art would know, may be a memory exchange unit, or a MXU. A MXU may perform operations such as logic address to physical address translation as well as forwarding read/write data from/through a memory interface unit (MIU) so that it is synchronized with the graphic engine's logic address.

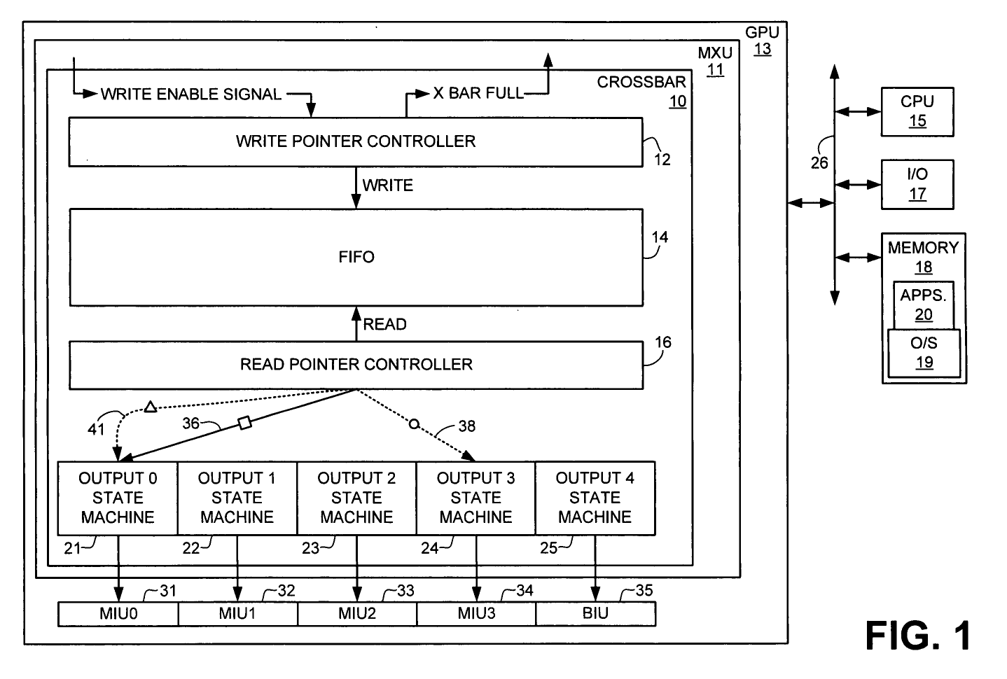

FIG. 1 is a diagram of a computing device having a CPU 15 coupled to a GPU 13, which includes a MXU 11, as described above. The computing device of FIG. 1 may also include one or more input/output devices 17, memory 18, which may contain an operating system 19 and one or more applications 20 (as well as other software), all coupled by bus 26. This computing device of FIG. 1 is a mere nonlimiting example and one of ordinary skill in the art would know of other components and/or configurations that could be utilized with the computing device of FIG. 1.

MXU 11 of FIG. 1 may contain a crossbar component that accepts one or more inputs and has one or more outputs. More specifically, as shown in this nonlimiting example, crossbar 10 may be a device having one input with the capability to route signals received on the input to one of five (or more in other nonlimiting examples) outputs.

Crossbar 10 may be configured with a write pointer controller, or other writing controller, 12 that accepts a write enable signal containing a destination ID as well as data to be forwarded on to one of five outputs in crossbar 10, and ultimately from a MXU. Write pointer controller 12 may store data received in the write enable signal into a memory component, FIFO 14, in this nonlimiting example. As a further nonlimiting example, FIFO 14 may be configured as a 600-bit memory device for storing data received by write pointer controller 12.

Crossbar 10 in this nonlimiting example may also include a read pointer controller, or other reading controller, 16 that may read the contents of FIFO 14 in the order in which data is written into FIFO 14. Depending upon the destination ID of data stored in FIFO 14, read pointer controller 16 may forward such data to one of five output state machines 21-25, as shown in FIG. 1. Each of output state machines 21-25 may be coupled to another component in the GPU 13 such as a memory interface units (MIU) 0-3 (reference numerals 31-34) or a bus interface unit (BIU) 35, in this nonlimiting example.

As one of ordinary skill in the art would know, FIFO 14 may be typically used in this situation in crossbar 10 to store data so that it may be forwarded to different outputs, as shown in FIG. 1. Because of the nature of FIFO 14, as one of ordinary skill in the art would know, reading current data from FIFO 14 may be delayed until previously written data in FIFO 14 is read out by read pointer controller 16.

As a nonlimiting example, if output 0 state machine (reference numeral 21) has data stored in FIFO 14 in the first entry position of FIFO 14, and output 3 state machine (reference numeral 24) has data stored in FIFO 14 in the second entry position, one of ordinary skill in the art would know that each entry position would be read out sequentially. Continuing this nonlimiting example, if output 0 state machine (reference numeral 21) has a next data entry in the third entry position, the next data for output 0 state machine (reference numeral 21) in entry position will be delayed until data for output 3 state machine 24 is read out of entry position of FIFO 14.

This is graphically shown in FIG. 1, wherein read pointer controller 16 may route the data in the first entry position of FIFO 14 according to the squared-lined path 36 to output 1 state machine (reference numeral 21). Dashed line 38 (circle-lined path), which represents the data path for the second entry position of FIFO 14 and indicates that data may be forwarded to output 3 state machine (reference numeral 24) after the data in the first entry position of FIFO 14 is forwarded to output 0 state machine (reference numeral 21).

Yet, as described above, if MIU 3 (reference numeral 34) is delayed and not ready to receive the data from output 3 state machine (reference numeral 24), the reading operation on circle-lined path 38 may not take place until such time when MIU 3 (reference numeral 34) is ready for the data. Accordingly, the next data in the third entry position of FIFO 14 designated for output 0 state machine (reference numeral 21) that may be forwarded on triangle-lined path 41 may not be communicated to output 0 state machine (reference numeral 21) until the data in the second entry position of FIFO 14, which is forwarded from read pointer controller 16 to output 3 state machine (reference numeral 24) via circle-lined path 38, is executed. Consequently, crossbar 10 of FIG. 1 may introduce delay into the GPU 13 such that the GPU 13 may not operate as fast and efficiently as it otherwise could be configured to do.

Thus, there is a heretofore unaddressed need to overcome the deficiencies and shortcomings described above.

### SUMMARY

A MXU of a GPU has an output independent crossbar. The output independent crossbar comprises a writing controller having an input configured to receive a communication containing data and a destination ID. The crossbar includes a memory having a plurality of separate entities coupled to the writing controller. The writing controller searches for an available memory entity for storing the data. As a nonlimiting example, the writing controller cycles through the memory entities searching for a next available memory entity. Memory entities may have an availability indicator that may be set to a first state when full and a second state when available. Upon identifying an available memory entity, the writing controller writes the data to the available memory entity.

A reading component containing a plurality of reading controllers is coupled to each entity of the memory. Each reading controller corresponds to a particular output and reads data from a memory entity upon receiving indication that the memory entity contains data for its corresponding output. The writing controller may inform a particular reading controller via a FIFO memory for the particular reading controller that data is stored in one of the memory entities and is designated for the output associated with the particular reading controller. The reading controller may then read data in the memory entity designated for its associated output and forward the data to that output.

Thus, the outputs of the crossbar may operate independently and not be delayed by any other output that may not be prepared to receive its data from one of the memory entities. More specifically, the separate reading controllers may enable reading of any memory entity containing data designated for its output irrespective of the state of other memory entities containing data designated for another output.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a diagram illustrating a computing device having a GPU that includes a MXU with a crossbar wherein outputs may be delayed due to operation of a FIFO memory.

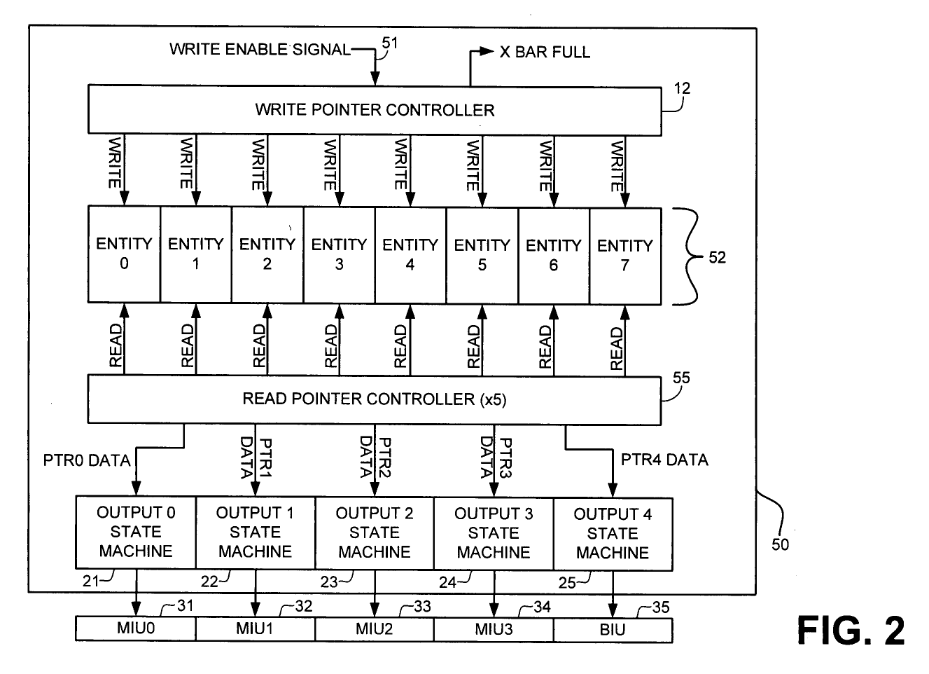

FIG. 2 is a diagram of crossbar that overcomes the shortcomings of the crossbar of FIG. 1 such that that one input may be coupled to any of the five output channels according to a destination ID.

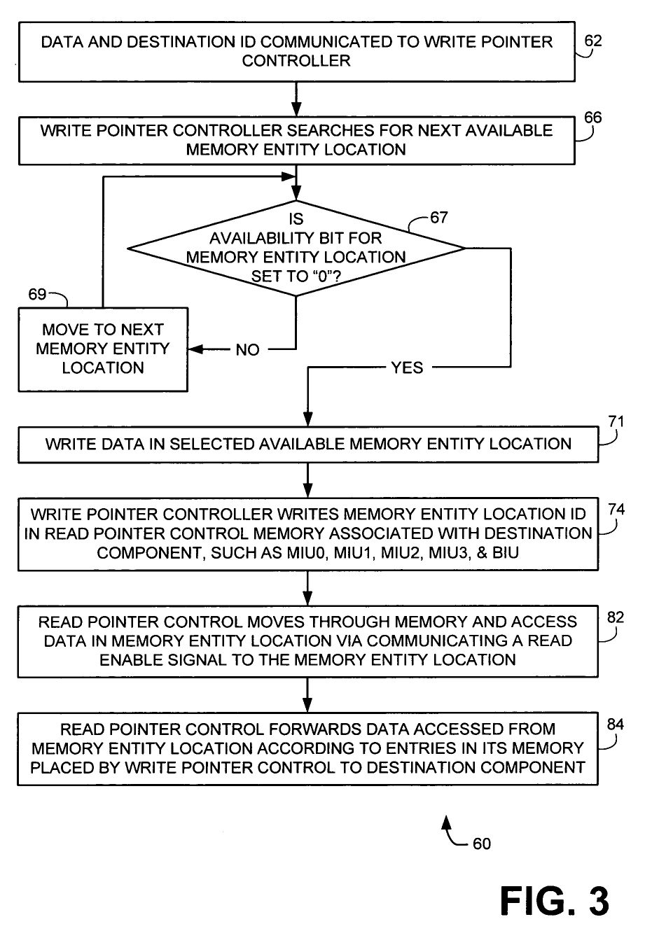

FIG. 3 is a flow chart diagram depicting the steps for the crossbar of FIG. 2 to route an input channel to a plurality, such as five, output channels without delay.

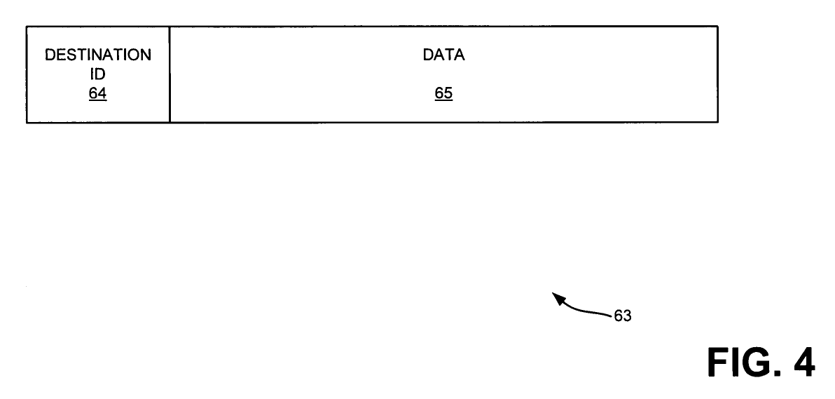

FIG. 4 is a diagram of the destination ID and accompanying data that may be received by the write pointer controller of FIG. 2 in storing data in one of the entity locations of FIG. 2.

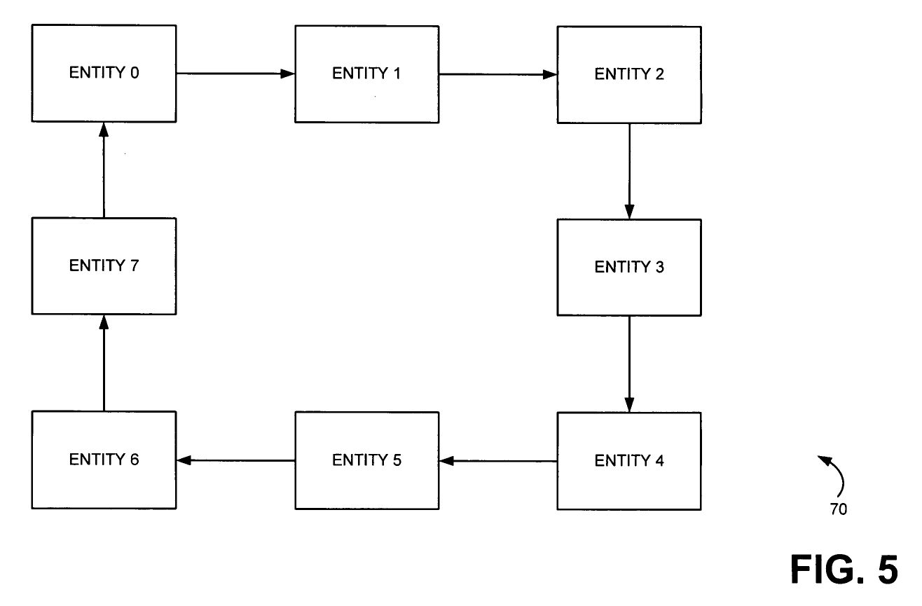

FIG. 5 is a diagram depicting an order for the write pointer controller of FIG. 2 to select a memory entity for storing data.

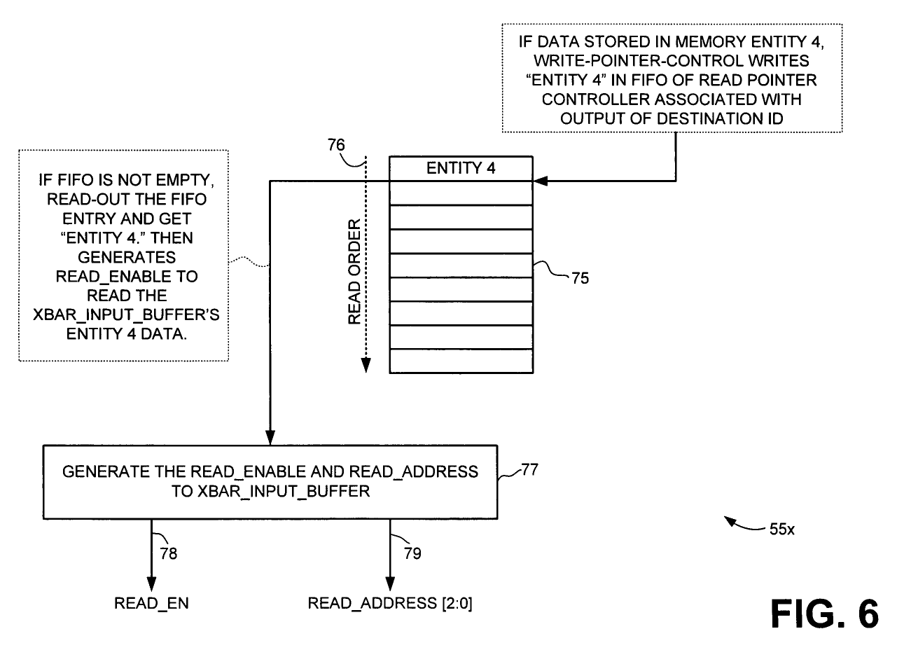

FIG. 6 is a diagram depicting a portion of one of five read pointer controllers of FIG. 2.

### DETAILED DESCRIPTION

FIG. 2 is a diagram of crossbar 50 that, unlike crossbar 10 of FIG. 1, is configured with an 8-entity memory 52 for establishing independent outputs. In this nonlimiting example, write pointer controller 12 may receive a write enable signal on path 51 that may be output to one of five components 31-35, which may include MIU 0, MIU 1, MIU 2, MIU 3, and/or BIU, as described above.

Instead of FIFO 14, as described in FIG. 1, crossbar 50 may be configured with, in this nonlimiting example, eight separate entity memory locations for receiving data written by write pointer controller 12. As described in more detail below, write pointer controller 12 may select one of eight memory entities 52 for storing data until the read pointer controller 55 reads the data therefrom.

Read pointer controller 55 may, in one nonlimiting example, contain five identical components for retrieving data for the output state machines (reference numerals 21-25) shown in FIG. 2. Each of the read pointer controllers 55 may access any of the eight memory entity locations 52 for reading data and forwarding the same to the appropriate output. Thus, as write pointer controller 12 may write data for MIU 0 (reference numeral 31) in memory entity location 3 of memory 52, and also write data in memory entities 1 and 6 for MIU 3 (reference numeral 34), each of these components may receive their designated data independent of each other and not sequentially and, therefore, delayed, as described above.

FIG. 3 is a flow chart diagram 60 that depicts the operation of crossbar 50 of FIG. 2 and is described in conjunction with FIG. 2. In step 62, as shown in FIG. 3, data and a destination ID may be communicated to the write pointer controller via the write enable signal path 51, or other similar communication path, from a source component in the GPU. FIG. 4 is a diagram of the communication 63 that may be received via the write enable path 51. In FIG. 4, communication 63 may include the destination ID 64 and the data 65 that is communicated to the write pointer controller 12 in step 62 described above.

Upon receipt of the communication 63, the write pointer controller 12 moves to step 66 and searches for a next available memory location in memory 52 of FIG. 2. In this nonlimiting example, memory 52 may not be configured as a FIFO such as FIFO 14 of FIG. 1, but instead may be configured as a memory having eight separate memory locations.

In at least one nonlimiting example, write pointer controller 12 may be configured to write data into the memory entities of memory 52 that are empty or otherwise do not contain any unread data. Write pointer controller 12 may cycle through the various memory entities of memory 52 in a predetermined fashion to determine if one of the memory entities is available for receiving communication 63 containing data 65 on write enable signal path 51.

In at least one nonlimiting example, each memory entity location of memory 52 may be configured with an availability indicator, or bit, which one of ordinary skill in the art may also recognize as a “dirty bit.” If a particular memory entity location is tall, meaning that data 65 has been written to but not yet read out from the memory entity location, the availability bit may be set to, as a nonlimiting example, “1.”

In being set to “1,” the write pointer controller 12 may recognize the memory entity location as being unavailable, as shown in steps 67 and 69 of FIG. 3. Thus, in step 66 of FIG. 3, the write pointer controller searches for a next available memory entity location in memory 52 for storing data received on write enable signal path 51. In doing so, the write pointer controller 12 executes step 67, as discussed above, to determine if the availability bit for a next memory entity location is set to “0.” If the availability bit is not set to “0,” but is a “1,” the write pointer controller 12 may look to a next memory entity location to determine its availability, as shown in step 69, and so on.

FIG. 5 is a diagram 70 of a rotational order in which the write pointer controller 12 may follow to locate an available memory entity location that is, as a nonlimiting example. In this nonlimiting example, if a current write point location is on memory entity 7, upon receipt of new data on write enable signal path 51 (FIG. 3), the write pointer controller 12 may evaluate the availability of memory entity 0. However, if the availability bits for entity 0 and 1 happen to both be set to “1,” then each of these memory entities have data written in but not yet read from their respective locations. The write pointer controller 12 may then skip both memory entity 0 and entity 1 and evaluate the availability bit for memory entity 2. However, if all memory entities are full, then the write pointer controller may return a signal, such as a memory full signal, to the source component of the GPU (not shown) indicating such on path 53, which is shown in FIG. 2.

In step 67 of FIG. 3, and further in this nonlimiting example, if the availability bit for memory entity 2 is set to “0,” which means that an available memory entity 52 is located, the write pointer controller 12 may then move to step 71 of FIG. 3. Step 71 provides that the write pointer controller 12 writes the data 65 of FIG. 4 to the recognized available memory entity location, which, in this nonlimiting example, is memory entity 2.

As discussed above, in regard to FIG. 4, the communication 63, which contains both a destination ID 64 and data 65, identifies the particular output of the crossbar 50 of FIG. 2. Thus, in step 74, the write pointer controller 12 may forward the destination ID 64, which may constitute an identifier or may contain identifying information, to the corresponding read pointer controller 55 for the output associated with the destination which, in this nonlimiting example of FIG. 2, may be MIU 0, MIU 1, MIU 2, MIU 3, or BIU (reference numerals 31-35 of FIG. 2).

As discussed above, read pointer controller 55 may actually contain five identical read pointer controllers (in this nonlimiting example) that are associated with their respective output state machines 21-25, which, in turn, are coupled to their respective outputs. Read pointer controller 55x of FIG. 6, therefore, is merely one representative nonlimiting example of a read pointer controller that may be part of read porter controller 55 of FIG. 2. One skilled in the art would know that read pointer controller 55 may contain five or more such instances of the components shown in FIG. 6, which may correlate to the number of outputs for crossbar 50.

As shown in FIG. 6, each read pointer controller 55x may include a FIFO memory 75 that receives the destination ID 64 of communication 63, which is also depicted in step 74 of FIG. 3. Stated another way, the write pointer controller 12 of FIG. 2 may forward the destination ID 64, which corresponds to a particular output to the appropriate read pointer controller 55x such that it is stored in FIFO memory 75. In this nonlimiting example of FIG. 6, by virtue of data being written into FIFO memory 75, the read pointer controller 55x may recognize that as a message that data 65 for the output associated with the read pointer controller 55x is stored in entity 4 of memory 52.

When FIFO memory 75 is written to, component 77 of the read pointer controller 55x may generate a read enable signal (also shown in FIG. 2) so as to retrieve the data contents of memory entity 4 of memory 52, as also depicted in step 82 of FIG. 3. The read enable signal from component 77 may be forwarded from read enable line 78 to the memory entity 4 of memory 52 according to the address communicated on path 79.

As a nonlimiting example, read pointer controller 55x of FIG. 6 may be designated for output 0 state machine 21 that is coupled to MIU 0 (reference numeral 31). Thus, FIFO memory 75 may contain a number of entry locations of data stored in memory 52 that should be forwarded on to MIU 0 (reference numeral 31), which may be equal to, greater than, or less than the number of memory entities. The additional entity IDs may be stored in FIFO memory 75 in sequential order such that the component 77 will work through the FIFO memory 75, as depicted by arrow 76, to retrieve data from the various memory entity locations 52 in the proper order, which is also shown in step 84 of FIG. 3. In this way, data in memory 52 is, thereafter forwarded to output 0 state machine 21 and on to MIU 0 (reference numeral 31).

Thus, each of the outputs (31-35 of FIG. 2) essentially has its own read pointer controller 55x. Plus, separate memory entities 0-7 of memory 52 operate independently of each other such that no single output can delay data designated for another output, as described herein.

Write pointer controller 12 may store data from various communications all designated, as a nonlimiting example, for output 0 state machine (reference numeral 21) in memory entities 0, 2 and 4 of memory 52 (assuming available). Likewise, data in other communications 63 received by write pointer controller 12 for output 4 state machine (reference numeral 25), as a nonlimiting example, may be stored in memory entities 1 and 3 of memory 52. As stated above, read pointer controller 55 may be configured with five identical read pointer controls such that the one designated for output 0 state machine (reference numeral 21) accesses the data stored in entities 0, 2, and 4 of memory 52 without any delay or regard to the operation of the read pointer controller corresponding to output 4 state machine (reference numeral 25), that accesses data in entities 1 and 3 of memory 52. Thus, one of ordinary skill in the art would know that each of the read pointer controllers in read pointer controller 55 operate independently of each other to access the contents of the entities of memory 52 so as to forward data to the appropriate output.

Furthermore, the availability bits of each memory entity of memory 52 may be toggled between “1” and “0,” as described above, to designate available and unavailable status so that write pointer controller 12 may continue to load the various memory entities of memory 52 based on availability. This scheme enables data to move from write pointer controller through read pointer controller 55 to the various outputs even if one of the end outputs is tying up a number of the entities of memory 52. In such a case, even if a number of the entities of memory 52 are utilized, the remaining number are still available to the write pointer controller 12 and the rest of the outputs of crossbar 50 of FIG. 2. In establishing each of the output channels independent from each other in this fashion, no one output has to wait for another output to finish a request before data can be forwarded to that output. Plus, in establishing the write pointer controller 12 to utilize the next available memory entity location for any output, memory 52 may be fully utilized even in unbalanced output conditions where one of the outputs experiences heavy traffic in respect to any of the other outputs. This method, therefore, essentially gives each of the MIUs and BIU a dedicated stream from the write input to the five outputs, as shown in this nonlimiting example described herein.

One of ordinary skill in the art would also know that memory 52 could be constructed of a larger or smaller number of memory entities than as shown and described herein. Likewise, the number of outputs of crossbar 50 may be increased or decreased, with the corresponding number of read pointer controllers 55x varying in similar fashion.

The foregoing description has been presented for purposes of illustration and description. It is not intended to be exhaustive or to limit the disclosure to the precise forms disclosed. Obvious modifications or variations are possible in light of the above teachings. The embodiments discussed, however, were chosen, and described to illustrate the principles disclosed herein and the practical application to thereby enable one of ordinary skill in the art to utilize the disclosure in various embodiments and with various modifications as are suited to the particular use contemplated. All such modifications and variation are within the scope of the disclosure as determined by the appended claims when interpreted in accordance with the breadth to which they are fairly and legally entitled.

1. An output independent crossbar, comprising:
a writing controller having an input configured to receive a communication containing data and a destination ID;
a memory having a plurality of separately writeable and readable entities coupled to the writing controller and configured such that the writing controller writes data to an entity that is available; and
a plurality of reading controllers each coupled to each of the plurality of entities, each of the plurality of reading controllers being associated with an output of the crossbar and configured to read data written to the plurality of entities designated for the output associated with the reading controller and also configured to forward read data to a destination associated with the output.

2. The crossbar of claim 1, further comprising:
an output state machine coupled to each of the plurality of reading controllers configured to receive data retrieved from an entity of the memory and to communicate the data to a destination component.

3. The crossbar of claim 1, further comprising:
a FIFO memory in each of the plurality of reading controllers configured to receive an identifier from the writing controller indicating a particular memory entity containing data to be retrieved and forwarded to a particular output associated with a particular reading controller.

4. The crossbar of claim 3, wherein the particular reading controller generates a read enable signal to read the contents of the particular memory entity identified by the identifier read from the FIFO memory.

5. The crossbar of claim 1, further comprising:
availability indicators associated with each of the plurality of entities of the memory configurable to a first state indicating unavailability for receiving data and configurable to a second state indicating availability for receiving data from the writing controller.

6. The crossbar of claim 5, wherein the availability indicator for a particular entity is set to the first state after the writing controller writes data to the particular entity.

7. The crossbar of claim 5, wherein the availability indicator for a particular entity is set to the second state after the reading controller reads data from the particular entity in which the writing controller previous wrote data to the particular entity.

8. The crossbar of claim 5, wherein the writing controller evaluates the availability indicator for one or more memory entities in a predetermined order until identifying a memory entity with an availability indicator having the second state.

9. The crossbar of claim 5, further comprising:
a communication path coupled to the writing controller and one or more source components that are configured to send the communications containing the data and the destination ID to the writing controller, the communication path configured to pass a signal from the writing controller back to the one or more source components when the availability indicator for each of the plurality of entities is set to the first state.

10. A method for a crossbar in a GPU to route communications received at an input in the crossbar to a plurality of outputs in the crossbar, comprising the steps of:
searching for a next available memory entity of a plurality of memory entities in the crossbar for storing the communications containing data and a destination ID;
writing the data to the next available memory entity;
forwarding identifying information for the next available memory entity to a memory for a particular reading controller of a plurality of reading controllers, the particular reading controller associated with an output corresponding to the destination ID;
retrieving the identifying information from the memory of the particular reading controller;
reading the data from the next available memory entity as identified by the retrieved identifying information; and
forwarding the data to the output of the crossbar corresponding to the destination ID.

11. The method of claim 10, wherein the memory of the particular reading controller has a number of positions that is equal to the number of entities of the plurality of memory entities.

12. The method of claim 10, further comprising the step of:
cycling through the plurality of memory entities in search of the next available memory entity in a predetermined order so that an availability of each memory entity is evaluated once before the availability of any other memory entity is evaluated a second time.

13. The method of claim 10, wherein the next available memory entity is the memory entity having an availability indicator identifying the memory entity as available for receiving data.

14. The method of claim 10, wherein the memory of the particular reading controller is a FIFO memory.

15. The method of claim 10, further comprising the step of: generating a read enable signal to read the contents of a memory entity identified by the identifying information stored in the particular reading controller memory.

16. The method of claim 15, wherein a number of read enable signals that can be generated at one time to read contents of the plurality of memory entities is equal to the number of the plurality of reading controllers.

17. The method of claim 10, further comprising the step of:
generating a memory full signal if no next available memory entity of the plurality of memory entities is identified after evaluating an availability status for each memory entity of the plurality of memory entities.
